(19) United States
(12) Patent Application Publication
(10) Pub. No.: US 2015/0247053 A1
(43) Pub. Date: Sep. 3, 2015

(54) VINYL ESTER-BASED COPOLYMER DISPERSIONS FROM A CONTINUOUS TUBULAR EMULSION POLYMERIZATION PROCESS

(71) Applicant: CELANESE EMULSIONS GMBH, Sulzbach (DE)

(72) Inventors: Alexander Madl, Frankfurt am Main (DE); Rajeev Farwaha, Belle Mead, NJ (US); Philip Confalone, Raritan, NJ (US); David Adams, Bad Soden (DE)

(21) Appl. No.: 14/396,293

(22) PCT Filed: Apr. 23, 2013
(86) PCT No.: PCT/US2013/037742

§ 371 Date: Oct. 22, 2014

Related U.S. Application Data
(60) Provisional application No. 61/637,699, filed on Apr. 24, 2012.

(51) Int. Cl. C09D 131/04

(52) U.S. Cl. CPC C09D 131/04; C08K 3/346

(57) ABSTRACT

Disclosed are aqueous polymer dispersions which can be used as binders in paper coating compositions. Such dispersions are made using a continuous polymerization process involving a tubular reactor with a continuous loop section and a secondary line section and comprise a polymer of polymerized copolymers (a) a vinyl ester, (b) an ethylenically unsaturated mono or di-carboxylic acid or half ester of a di-carboxylic acid, and (c) a comonomer having a multifunctional moiety.

### FIELD

The present invention relates to aqueous dispersions of vinyl ester-based polymers made in a continuous tubular reactor process and to their use in paper coating formulations.

### BACKGROUND

Pigmented paper coating formulations generally comprise an aqueous synthetic polymer binder emulsion and pigment and may contain other additives typically used in the paper coating art. Illustrative of the polymer binders in the emulsions are vinyl acetate copolymers and interpolymers, including vinyl acetate/ethylene (VAE) and vinyl acetate/alkyl acrylate copolymers and interpolymers, and styrene/butadiene styrene/acrylate copolymers. Such copolymers and interpolymers can also contain other co-monomers such as, for example, a copolymerized ethylenically unsaturated mono- or dicarboxylic acid or other unsaturated co-monomers which can function as cross-linking agents.

U.S. Pat. No. 4,395,499, for example, discloses high strength pigment binders for paper coatings having increased water retention and stability. The coating compositions contain an aqueous synthetic polymer latex comprising a dispersed interpolymer of a vinyl ester; a polyethylenically unsaturated co-monomer which can be triallyl cyanurate, triallyl isocyanurate, diallyl maleate, diallyl fumarate, divinyl benzene or diallyl phthalate; an ethylenically unsaturated mono- or dicarboxylic acid co-monomer or half ester thereof; and optionally an alkyl acrylate co-monomer.

Notwithstanding the availability of these various types of paper coating binder emulsions, there is a persistent need for coated paper and coated paperboard producers to identify low cost paper coating emulsions (i.e., paper coating binders) which provide increased binding strength when the compositions are applied to paper and paperboard products. Most often, binding strength is quantified by a paper test called the IGT pick resistance test. In the IGT pick test, the greater the IGT value, the stronger the binding strength.

A variety of emulsion polymerization components and techniques can influence binding strength, but, in general, vinyl acetate-based binders (e.g., polyvinyl acetate, vinyl acetate-ethylene, vinyl acetate-acrylate, and the vinyl acetate-based binders discussed above) are known to provide lower binding strength than more commonly used coating binders like styrene butadiene and styrene acrylics. To compensate for the lower IGT pick resistance provided by paper coating compositions using such vinyl ester based binders, higher binder levels are required, which, of course, detracts from the profitability of the coated paper and paperboard products made with these types of coating binders. In addition, those skilled in the art will appreciate that high binder levels may result in adverse properties, e.g., reduced ink absorption.

Over the years, a few vinyl acetate/ethylene (VAE) copolymers and interpolymers have been developed for paper coating applications. U.S. Pat. No. 3,337,482, for example, discloses paper coating compositions containing pigments and binder emulsions comprising copolymers of ethylene, vinyl acetate and ethylenically unsaturated mono- or di-carboxylic acids such as acrylic acid or maleic acid. The binder emulsions of the '482 patent are prepared by emulsion polymerization of the co-monomers using a nonionic emulsfier which contains polyoxyethylene oleyl or lauryl phenyl ethers.

U.S. Pat. No. 5,177,128 discloses a paper coating composition containing a first polymer network intertwined on a molecular scale with a second polymer network. The process involves making a first polymer emulsion and mixing a second monomer emulsion with the first polymer emulsion. The emulsion mixture is polymerized to provide a first polymer network with is intertwined on a molecular scale with the second polymer network.

The most effective nonionic emulsifiers found to stabilize emulsions of VAE copolymers belong to a general class of nonionic surfactants called alkylphenol ethoxylates (APEs). APEs have been typically used in VAE latex products to improve emulsion polymerization and film forming, and in coating formulations to provide pigment wetting. However, these APE compounds are believed to break down in the environment into related compounds that are persistent in the environment and act as endocrine disruptors. Due in part to regulations in Europe, as well as recently adopted water quality criteria in the United States, the evolving environmental controls on APEs are reminiscent of the 1970s ban on lead compounds in paint. Given this adverse regulatory situation, the use of APE-type nonionic emulsifiers in VAE emulsion-containing products is increasingly viewed as disadvantageous.

In light of the developing need to address potential problems with utilizing phenol free-emulsifiers in place of the heretofore more conventionally used APEs, and in view of the need to overcome issues associated with handling ethylene gas on a large scale basis, the use of VAE-based paper coating compositions has to date been of only limited commercial significance. Other issues including possible lack of FDA compliance and/or relatively high Volatile Organic Compound (VOC) content have also worked against the commercial use of VAE-based coating compositions.

More recently equipment and expertise has been developed to polymerize and stabilize environmentally-friendly vinyl ester/ethylene, e.g., vinyl acetate/ethylene (VAE), coating binders on a commercial production scale. Accordingly, the current state of the emulsion polymerization art with respect to surfactant-stabilized, APE-free, vinyl ester-based polymers make such polymeric materials very desirable candidates for paper/paperboard coating applications. However, traditionally vinyl acetate-containing dispersion polymers are made in stirred tank reactors. In this situation, the throughput is limited by the reactor volume. The making of large production amounts of polymer requires a relatively large space and a high cooling capacity. Furthermore, significant time is required for discharging and preparing the stirred reactor for the next batch, increasing the total batch cycle time.

Thus, a continuous loop process for making vinyl ester-based dispersion polymers for paper/paperboard coating would provide commercial advantages. Such commercial potential for vinyl ester-based dispersions can be realized if the binding strength exhibited by such vinyl ester-based binders can be made comparable to the binding strength of binders made using batch processes, including surfactant-stabilized, APE-free, VAE binders and non-vinyl ester-based binders such as those based on styrene butadiene and styrene acrylics. However, initial attempts at using a continuous process for making vinyl ester-based dispersion to achieve similar or improved paper coating properties to binders made from a batch process met with difficulty. For example, vinyl ester-based emulsions made from a continuous tubular reactor process had particles sizes similar to vinyl ester-based material made with a batch reactor, but had significantly lower IGT pick resistance values.

The need therefore exists for improved vinyl ester-based emulsion compositions made from continuous processes (optionally free of APEs), coating compositions utilizing these emulsion compositions and having desired binding strength characteristics, and continuous processes for making such emulsion compositions and coating compositions.

### SUMMARY

It has now been discovered that by preparing vinyl acetate-based emulsions using a continuous tubular reactor and with certain monomers, dispersions may be prepared having especially desirable physical properties, such as good pick strength. Such latex binders are desirable because they can be used to provide especially effective and environmentally friendly coating compositions for paper and paperboard applications that can be manufactured cheaply, efficiently, and with more predictable, or less variance in, properties.

In one embodiment, the present invention is directed to a composition comprising an aqueous dispersion of a polymer comprising at least the following polymerized comonomers: vinyl acetate, at least one ethylenically unsaturated mono or di-carboxylic acid or half ester of a di-carboxylic acid, and at least one multifunctional comonomer, and where the dispersion is prepared by a continuous emulsion polymerization in a reactor comprising a closed loop section and a secondary line section. In another embodiment of the present invention, the aqueous dispersion has a volume average particle size value, Dᵥ, of at least 150 nm

In yet another embodiment, the present invention is directed to a composition comprising an aqueous dispersion of a polymer comprising at least the following polymerized comonomers: vinyl acetate and at least one ethylenically unsaturated mono or di-carboxylic acid or half ester of a di-carboxylic acid, where the dispersion is prepared by a continuous emulsion polymerization in a reactor comprising a closed loop section and a secondary line section. Certain embodiments of the invention contain no multifunctional monomer.

Another embodiment of the present invention involves a composition comprising an aqueous dispersion of a polymer comprising at least the following polymerized comonomers: vinyl acetate, at least one ethylenically unsaturated mono or di-carboxylic acid or half ester of a di-carboxylic acid, and at least one multifunctional comonomer, and where the dispersion is prepared by a continuous emulsion polymerization in a polymerization reactor comprising a first section with a circulation loop with one or more inlets for raw material, a pump for circulating a reactor charge within the circulation loop, and a secondary line section not forming a closed loop connected to a discharge of the loop section.

### DETAILED DESCRIPTION

The present invention relates to aqueous polymer emulsions that demonstrate excellent dry pick strength when such emulsions are incorporated into coating compositions, and in particular into coating compositions for paper products. Emulsion polymers of the present invention comprise polymers formed from the continuous emulsion polymerization of comonomers: (a) a vinyl ester, (b) an ethylenically unsaturated mono or di-carboxylic acid or half ester of a di-carboxylic acid, and (c) a comonomer having a multifunctional moiety in a tubular reactor. The polymers may also contain additional comonomers, such as ethylene. The relative amounts of the comonomers in the emulsion polymers of the present invention may vary. The polymers are preferably colloidally dispersed in an aqueous medium comprising a surfactant.

The primary comonomer used in the preparation of the copolymer dispersion is a vinyl ester. The vinyl esters utilized in the formation of the dispersions herein are the esters of alkanoic acids, the acid having from one to about 13 carbon atoms. Typical examples include; vinyl formate, vinyl acetate, vinyl propionate, vinyl butyrate, vinyl isobutyrate, vinyl valerate, vinyl-2-ethyl-hexanoate, viny isooctanoate, vinyl nonate, vinyl decanoate, vinyl pivalate, vinyl versatate, and mixtures thereof. Of the foregoing, vinyl acetate is the preferred monomer because of its ready availability and low cost.

The vinyl ester preferably is present in the emulsion polymer in an amount ranging from 70 to 98 pphm (parts per hundred based on total monomer in the specified copolymer), e.g., from 75 to 85 pphm. More preferably, the vinyl ester content of the copolymer used in the emulsion of the coating compositions described will range from 78 pphm to 82 pphm.

The emulsion polymers of the present invention optionally include ethylene as a comonomer. Generally, a relatively high ethylene content in the copolymer is desired in order to provide a binder emulsion that is especially effective in formulating coating compositions that provide desirably high binding strength. Thus, the optional ethylene may comprise from 2 pphm to 30 pphm of the copolymer, e.g., from 10 to 25 pphm or from 18 to 22 pphm, when present. More preferably, ethylene will be present in the copolymer in an amount ranging from 12 pphm to 20 pphm.

Another comonomer of the present polymer dispersion is at least one monomer that introduces a carboxyl moiety into the polymer. Generally, any ethylenically unsaturated mono or di-carboxylic acid may be used to provide the carboxyl functionality. Examples of suitable acids include monocarboxylic ethylenically unsaturated acids such as acrylic, vinyl acetic, crotonic, methacrylic, tiglic, etc.; dicarboxylic ethylenically unsaturated acids such as maleic, fumaric, itaconic, maleic, citraconic, hydromuconic, allylmolonic, etc. as well as the half esters of these dicarboxylic acids such as mono(2-ethylhexyl) maleate, monoethyl maleate, monobutyl maleate, etc.

Another comonomer that may be included in the emulsion polymers described comprises a multifunctional comonomer. These multifunctional comonomers can be polyethylenically unsaturated andmay function as cross-linkers in the emulsion polymers. Examples of suitable multifunctional comonomers include triallyl cyanurate, triallyl isocyanurate, diallyl maleate, diallyl fumarate, dyvinyl benzene and diallyl phthalate. Preferred comonomers of this type include diallyl maleate and diallyl fumarate. Especially preferred is diallyl phthalate. This type of multifunctional comonomer will be generally present in the emulsion polymer in an amount from 0.05 pphm to 0.5 pphm More preferably, such multifunctional comonomer(s)/cross-linker(s) will be used in the first copolymer in amounts from 0.1 pphm to 0.3 pphm. However, certain embodiments of the present invention may be substantially free of multifunctional comonomer.

The vinyl ester-based emulsion polymers discussed can optionally comprise one or more additional non-functional comonomers. One type of such optional non-functional comonomer comprises further vinyl ester comonomers. Examples thereof are vinyl esters of monocarboxylic acids having one to eighteen carbon atoms (except those already used as the main comonomer), e.g. vinyl formate, vinyl propionate, vinyl butyrate, vinyl isobutyrate, vinyl benzoate, vinyl-2-ethyl-hexanoate, vinyl esters of an [alpha]-branched carboxylic acid having 5 to 11 carbon atoms in the acid moiety, e.g., Versatic™ acids, and the vinyl esters of pivalic, 2-ethylhexanoic, lauric, paimitic, myristic, and stearic acid. Vinyl esters of Versatic™ acids, more particularly VeoVa™ 9, VeoVa™ 10, and VeoVa™ 11, are preferred.

In one aspect, the emulsion and resulting coating composition of the invention comprises one or more external crosslinkers. Suitable external crosslinkers include carbonates such as ammonium zirconium carbonate (AZC) and potassium zirconium carbonate (KZC). The external crosslinker may be added to the emulsion optionally after polymerization. If present, the external crosslinker may be present in the emulsion in an amount from 1 to 10 wt. %, e.g., from 3 to 10 wt. %, based on the total weight of the blended emulsion.

As noted, the polymers used to form the aqueous dispersions herein are made from comonomers comprising a vinyl ester, an ethylenically unsaturated mono or di-carboxylic acid or half ester of a di-carboxylic acid, a multifunctional comonomer, and optionally ethylene and other comonomers. Preferably, these several types of comonomers will be present in the emulsion polymer in amounts relative to each other which serve to impart to the coating composition containing the emulsion polymer, e.g., paper coating composition, as hereinafter described, an IGT Dry Pick Value (also as defined hereinafter) of at least about 40, at least about 50, or at least about 60. These values are obtained using IGT Pick Test Oil of medium viscosity (52 Pa·s) at a testing speed of 2 cm per second and a testing pressure of 35 KgF.

Since IGT values may vary based on conditions employed, IGT values may also be expressed as a percentage (% IGT) of a control IGT value. For purposes of the present invention, the control IGT value is an equivalent IGT value determined based on a vinyl ester-based polymer from a batch process. Although % IGT may vary, according to some exemplary embodiments, % IGT Pick Value (Wet or Dry) may be greater than 70% of the control, e.g., greater than 80% of the control, or greater than 90% of the control.

The copolymer dispersion can be produced from the monomer mixture using emulsion polymerization techniques described more fully hereinafter. Within the copolymer dispersion, the copolymer will be present in the form of particles ranging in volume average particle size, Dᵥ, of at least 150 nm, such as from about 150 nm to about 600 nm, measured by laser aerosol sprectroscopy or another suitable method. More preferably, the copolymer dispersion will be present in the form of particles ranging in volume average particle size, Dᵥ, of from about 200 nm to about 500 nm, or about 300 to about 500 nm.

Particle size can be determined by means of laser aerosol spectroscopy techniques, or for example, a Coulter Counter LS230 (laser/light scatter, range 40 to 20,000 nm) is one instrument that can be used to measure particle size.

Depending upon co-monomer type, solubility and the monomer feeding techniques employed, the vinyl ester-based copolymer can be either homogeneous or heterogeneous in monomeric configuration and make-up. Homogeneous copolymers will have a single discreet glass transition temperature, T_{g}, as determined by differential scanning calorimetry techniques. Heterogeneous copolymers will exhibit two or more discreet glass transition temperatures and might exhibit core shell particle morphologies. Whether homogeneous or heterogeneous, the vinyl ester-based copolymer used herein will have glass transition temperatures, T_{g}, which range between about 0° C. and 35° C., more preferably between about 5° C. and 15° C. As is known, the T_{g} of the polymer can be controlled, for example, by adjusting the ethylene content, i.e., generally the more ethylene present in the copolymer relative to other comonomers, the lower the T_{g}.

### Stabilizers for Polymer Dispersions

The emulsion polymerization processes used to prepare the vinyl ester-based polymers in aqueous dispersion form can be carried out in the presence of a stabilization system which comprises one or more of certain types of anionic and/or nonionic surfactants as emulsifiers.

Suitable nonionic surfactants which can be used as emulsifiers in the emulsion stabilizing system of the coating compositions herein include polyoxyethylene condensates. A wide variety of nonionic surfactants of this type are disclosed in the hereinbefore-referenced U.S. Pat. No. 5,849,389. As noted above, however, such ethoxylated nonionic surfactants used to stabilize the binder emulsions of the present invention preferably do not include ethoxylated nonionics based on alkyl phenols.

The binder emulsions and coating compositions described herein are preferably substantially free of alkylphenol ethoxylates (APEs). For purposes of this invention, such emulsions and coating compositions are considered to be substantially free of APEs if they contain less than 500 wppm of alkylphenol ethoxylates. In other embodiments, the emulsion of the invention may comprise a minor amount of APEs.

Suitable anionic surfactants that can be used as emulsifiers in the binder latex components of the coating compositions, e.g., paper coating compositions, described herein include alkyl aryl sulfonates, alkali metal alkyl sulfates, sulfonated alkyl esters and fatty acid soaps. A wide variety of anionic surfactants of this type are also disclosed in the hereinbefore-referenced U.S. Pat. No. 5,849,389.

Following polymerization, the solids content of the resulting emulsion can be adjusted to the level desired by the addition of water or by the removal of water by distillation. Generally the desired level of polymeric solids content is from about 40 weight percent to about 70 weight percent based on the total weight of the respective emulsion, from about 40 weight percent to about 60 weight percent or from about 45 to about 55 weight percent.

The particle size of the emulsion can be regulated by the quantity of non-ionic or anionic emulsifying agent or agents employed. As a general rule, the greater the amount of the emulsifying agent employed, the smaller the average particle size.

### Copolymer Dispersion Preparation

The copolymer dispersions comprising the vinyl ester-based copolymers described herein can be prepared using emulsion polymerization procedures which result in the preparation of polymer dispersions in aqueous latex form. The emulsion polymerizations of the present invention are carried out in a tubular reactor comprising a closed loop section and a secondary line section. The closed loop section can be continuously charged with fresh monomers and water phase at substantially the same rate as the rate at which an overflow of reactor charge is discharged into a secondary line section, the reactor charge being continuously re-circulated within the closed loop section. Together with selection of reaction temperature, the discharge rate and the circulation rate can be balanced to achieve low residual monomer content. Preferably the secondary line section has a volume of less than twice the volume of the closed loop section. Optionally, the secondary line section is coiled.

The secondary line section can for example be provided with at least two separate cooling jackets in serial arrangement. This allows optimization of the different stages of polymerization when the reactor charge passes into the secondary line section. In one embodiment, a first part of the secondary line section is cooled to a lesser extent than a subsequent second part of the secondary line section. The first part can for instance be cooled to a relatively high temperature of 70° C. or higher to maximize polymerization, whereas the second part can be cooled to a greater extent, e.g., to 55° C. or less, so that the finished polymer emulsion is discharged to a storage tank at a reasonably low temperature.

Optionally, the secondary line section may have a diameter which is larger than the diameter of the line forming the closed loop section. With a larger diameter, the reactor charge will move through the secondary line section at a relatively slow speed. In another possible embodiment, the diameter of the secondary line section can be smaller than the diameter of the pipeline forming the closed loop section, which will increase the shear rate in the former. Preferably, the secondary line section itself does not form a closed loop and has one end connected to a discharge opening of the loop section.

The polymerization of the vinyl ester and other comonomers can take place in aqueous suspension and preferably the raw materials are provided by separate feed streams. These streams introduce fresh monomer and an aqueous solution of stabilizers known as the water phase or, e.g., a pre-emulsion of monomer and water with stabilizer and an aqueous stabilizer solution in a separate small stream. At the start of the reaction the reactor is filled with water phase made up in a solution tank. Other additions are also possible, particularly finished emulsion polymer (of the same or a different composition) from a previous run, optionally diluted to any concentration.

Agitation in the reactor is provided by virtue of an in-line circulation pump. Shortly after the feed streams start to flow, the monomers begin to react and heat is generated. The temperature is stabilized by cooling means, usually by controlled circulation of a cooling fluid (e.g. water) through a cooling jacket. The product flows to the cooling tank, where residual monomer converts to polymer. After cooling, the emulsion polymer is filtered to remove any oversize particles or gritty material and transferred to a product storage tank.

Optionally, the polymerization process may be carried out under pressure, for instance under a pressure of 10 to 150 bar. Alternatively, the polymerization may be carried out at ambient pressure.

In a typical polymerization procedure involving, for example, vinyl acetate/ethylene copolymer dispersions, the vinyl acetate, ethylene, and other co-monomers can be polymerized in an aqueous medium under pressures up to about 120 bar in the presence of one or more initiators, at least one emulsifying agent and a cellulose ether or polyvinyl alcohol protective colloid component. The aqueous reaction mixture in the polymerization vessel can be maintained by a suitable buffering agent at a pH of about 4 to about 7.

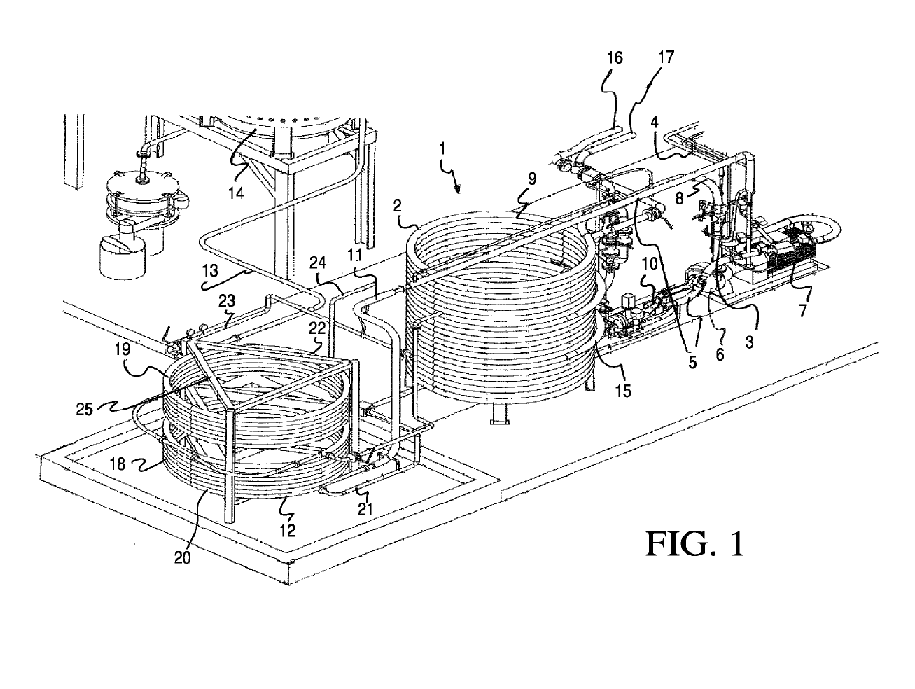

The invention is further illustrated by an example drawing. In the drawing, FIG. 1 shows a tubular reactor 1 for emulsion polymerisation. The reactor 1 comprises a circulation loop 2 with a monomer inlet 3, a water phase inlet 4, and a discharge outlet 5 for product. A circulation pump 6 driven by a motor 7 serves as a driving means for circulating a reactor charge within the circulation loop 2, via line 8 to the upper section of the coiled part 9 of the circulation loop 2. In the coiled part 9, the reactor charge flows down and via line section 10 back to the circulation pump, 6 where the main part of the reactor charge is recirculated again, except for the part that is discharged via outlet 5. The discharged reactor charge has a residual monomer content of about 5% by weight. To obtain a continuous polymerisation process, the outlet of the circulation loop 2 is such that the outflow rate equals the inflow rate of the raw materials and is substantially less than the flow rate of the recirculated material.

The reactor 1 further comprises a product take-off line 11 leading from the outlet 5 of circulation loop 2 to a coiled secondary line section 12. A discharge line 13 leads from the coiled section 12 to a cooling tank 14. The volume of the secondary line section 12 is about equal to the volume of the circulation loop 2.

The coiled tube of the circulation loop 2 is covered by a hollow cooling jacket 15, through which cooling water flows. The cooling jacket 15 is connected to a cooling water inlet 16 and a cooling water outlet 17.

The coiled secondary line section 12 is similarly cooled and has a lower part 18 and a separately cooled upper part 19. To this end, the lower part 18 is provided with a cooling jacket 20, connected to a water inlet 21 and a water outlet (not shown). Similarly, the upper part 19 is provided with a separate cooling jacket 22, connected to another water outlet 23 and a water inlet 24. The lower part 18 of the secondary line section 12 is connected to the discharge outlet 5 of the circulation loop 2 and is cooled to a lesser extent than the subsequently cooled upper part 19 of the secondary line section 12. The coiled secondary line section 12 is hung in a frame 25.

### Coating Compositions

To produce the desired paper coating composition, the polymer dispersion described above is generally combined with a pigment, such as kaolin clay, titanium dioxide and/or calcium carbonate, and the usual paper coating additives, which may include, for example, rheology modifiers such as CMC, sodium polyacrylates or sodium alginates; lubricants; crosslinkers; optical brighteners; biocides; dispersants; or other co-binders, such as polyvinyl alcohol, protein, e.g., casein or soy protein, or starch, as is well known to those skilled in the art. The coating compositions herein may also contain sufficient alkali to maintain the pH of the coating composition between 6 and 10, more preferably between 7 and 9.

Thus, in another embodiment, the invention is directed to a coating composition, preferably a paint, paper or paperboard coating composition, comprising an aqueous surfactant-stabilized, copolymer latex binder, and sufficient alkali to achieve a pH of 6 to 10, the latex binder having dispersed therein a copolymer of a vinyl ester having from 1 to 13 carbon atoms, an ethylenically unsaturated mono or di-carboxylic acid or half ester of the di-carboxylic acids, and a comonomer having a multifunctional moiety, wherein the latex binder is stabilized with anionic and/or non-ionic emulsifiers. The coating composition preferably further comprises one or more pigments. The composition preferably is substantially free of alkyl phenol ethoxylate surfactants.

The pigment used in the paper coating compositions herein may be any of those conventionally employed. Frequently, some or all of the pigment comprises clay, such as any of the clays customarily used for paper coating, including the hydrous aluminium silicates of kaolin group clays, hydrated silica clays, and the specific types of clays recommended in Chapters 10-16 of “Kaolin Clays and their Industrial Uses,” by J. M. Huber Corp. (1949), New York, N.Y.

In addition to clay, or as a complete replacement for clay, optical brighteners and/or paper pigments may also be utilized, such as, for example, calcium carbonate, titanium dioxide, or other coating pigments including plastic pigments, for example, polystyrene. The pigments, in particular calcium carbonate, may be present in amounts up to 50 wt. %, up to 75 wt. % or up to 97 wt. %, based on the total weight of the binder. Additionally, the composition may also contain other additives such as zinc oxide and/or a small amount of a dispersing or stabilizing agent such as sodium polyacrylate or tetrasodium polyphosphate (TSPP). The amount of binder in the paper coating composition may vary, but optionally ranges from 2.5 to 25 parts per 100 parts dry pigment, e.g., from 3.5 to 18 parts per 100 parts dry pigment.

The composition of the pigments in the paper coating composition may vary widely. In one embodiment, the pigment consists of calcium carbonate. In some other embodiments, the pigment comprises from 65 to 100 wt. % clay, from 0 to 35 wt. % secondary pigment, from 0.01 to 0.5 wt. % stabilizing agent; from 3 to 30 wt. % interpolymer latex (solids basis); from 0 to 25 wt. % cobinder; from 0 to 0.2 wt. % defoamer; and sufficient water to provide the desired level of solids. Coating compositions containing from about 40 wt % to 70 wt % solids are typical. The modification and formulation of the coating color using these materials will be within the knowledge of those skilled in the art.

The paper coating compositions of the invention may be applied to various substrates including paper such as groundwood and groundwood-free grades used for newspapers, advertisements, poster, books, magazines, or labels; paperboard such as solid bleached or unbleached sulfate and recycled grades used for folding cartons, beverage carriers, printing bristols, or liners; and building substrates such as wall coverings, wall board, or ceiling tile. In one embodiment, the paper coating composition can be used to coat paper intended for rotogravure printing or digital printing, such as ink jet printing.

The amount of the paper coating composition applied to the substrate is generally in the range of 1 g/m² to 30 g/m², and preferably in the range of 3 g/m² to 12 g/m². The paper coating composition may be applied in a single step or by using two or more steps to build the final coat weight. Further, the paper coating composition may also be applied to opposite sides of the substrate either simultaneously or in separate coating steps.

The paper coating composition may be applied to the substrate by techniques well known to those in the art. For example, the paper coating composition may be applied with a roll applicator such as a metered size press; a blade coater such as a short or long dwell time applicator; air knife coater; rod coater; slot die coater; jet applicator; or brush. Preferred coating methods for high speed application include the use of a blade coater or a metered size press.

The paper coating compositions of the present invention, which contain the particular blended latex emulsions described herein, provide highly desirable binding characteristics when applied as coating to paper substrates of the type described above. The binding performance can be quantified by means of a parameter called dry pick strength, and in particular by means of parameters known in the industry as Dry and Wet Pick Values as specifically defined hereinafter.

“Picking” is defined as the lifting of a coating, film or fibers from the surface of the base paper during printing. When a print wheel makes contact with a paper sample to deposit the ink, then subsequent negative forces are exerted on the paper as the inked print wheel is removed from the paper surface. The dry pick strength of the coated paper is measured with a method that consists of printing a strip of the coated paper in a print tester at an accelerating rate. The accelerated speed of the print wheel and the tack rating of the ink are adjusted to determine the strength of the coated paper sample at specific printing conditions. If the combination of print wheel speed and ink tack is great enough, then resulting negative forces create picking, which may appear as: white areas on the surfaces of the print wheel and coated paper sample, as blisters and textured areas on the surface of the coated paper sample, as delamination (surface layer removal) of the coated paper sample, or as tearing (complete strength failure) of the base paper sample.

Evaluation of the picking effect exhibited by selected paper substrates coated with any given type of paper coating composition can be used to quantify the binding strength and coating performance of that composition. Picking evalution is carried out by means of IGT pick testing according to standard methods of measurement by the Technical Association of the Pulp and Paper Industry (TAPPI) as well known in the art. A measure of dry and wet binding strength is provided by IGT Pick testing pursuant to TAPPI Useful Method UM 591, Surface Strength of Paper, the entirety of which is incorporated herein by reference. The IGT dry pick strength measures the speed, in cm/sec, required to lift the paper coating off the surface of a paper substrate strip when printed using an ink roller and standard conditions as described in UM 591. Higher IGT dry pick numbers indicate better resistance of the coated substrate to picking and hence higher strength coating performance.

The Dry Pick Values as used herein are the values obtained from the dry pick testing of the coated boards as described above using an IGT Testing Systems AIC2-5 Printability Tester under conditions which include use of medium viscosity oil, 2 cm/sec, and 35 KgF. As noted above, the paper coating compositions of the present invention, when using the blended latex emulsions of the present invention, preferably will exhibit Dry Pick Values in accordance with the above-described testing of at least about 50, at least about 60, or at least about 70, with crosslinker or substantially free of crosslinker. Generally, the paper coating compositions of the present invention preferably exhibit Dry Pick Values of from about 50 to about 80, e.g., from 60 to about 80, with crosslinker or substantially free of crosslinker.

The paper coating compositions of the invention also preferably provide desirable brightness characteristics. Brightness may be measured by the TAPPI Brightness standard T452, “Brightness of pulp paper and paperboard (directional reflectance at 457 nm),” the entirety of which is incorporated herein by reference. In this test, a specifically designed directional geometry brightness tester is employed. A brightness filter is employed such that the values measured by the instrument will match those on a set of opal glass and paper standards within set tolerances. The brightness may be reported as a percentage of how much light is reflected. Thus, greater brightness values represent a brighter or whiter coated paper. In some exemplary embodiments, binders and paper coating compositions of the invention provide a TAPPI T452 brightness value of at least 70, at least 79 or at least 90, or in terms of ranges, from 70 to 97, from 70 to 90 or from 75 to 85.

The paper coating compositions of the present invention also preferably have a high degree of gloss, which can be expressed in terms of TAPPI T480 om-05, the entirety of which is incorporated herein by reference. The T480 standard involves the measuring for specular gloss with a glossmeter at 75° angle from the plane of the paper. In some exemplary embodiments, binders and paper coating compositions of the invention provide a TAPPI T480 gloss value of at least 30, at least 35 or at least 40, or in terms of ranges, from 30 to 60, from 30 to 50 or from 35 to 45.

In addition, the paper coating compositions of the present invention preferably are very smooth (have a low degree of roughness). Roughness may be measured according to TAPPI T555 om-4, the entirety of which is incorporated herein by reference. The T555 standard simulates printing press conditions. The instrument contains an internal gas flow restrictor with closely controlled pressure drop versus flow characteristics. The air flow over the surface of the paper or paperboard is calculated by comparing the pressure drop across the measuring head and the paper test surface with that across the flow restrictor. In some exemplary embodiments, the binders and paper coating compositions of the invention provide a TAPPI T555 roughness value expressed in microns of roughness of less than 3.2, less than 3.0, less than 2.8, or less than 2.5, or in terms of ranges, from 1.5 to 3.2, from 2.0 to 3.0 or from 2.2 to 2.8.

Depending on the formulation employed, the binder and paper-coating compositions of the present invention may comply with U.S. Food & Drug Administration (FDA) regulations concerning paper products that can be used in contact with food. In particular, FDA regulations embodied in 21 CFR §176.170 and 21 CFR §176.180 indicate the types of paper coating composition components, including components of polymers used in such compositions, which can be utilized to coat paper for eventual use with food products.

### EXAMPLES

The dispersions of the present invention, and the performance of such dispersions in the paper coating compositions herein, are illustrated by way of the following non-limiting Examples.

### Example Preparation

All the aqueous polymer dispersions of the examples were prepared with a continuous tubular reactor with a closed loop section and a secondary line section. The method of preparation for the liquid monomer compositions of the examples using the continuous loop reactor was as follows: (1) The loop section and the secondary line section of the reactor were filled with water. (2) The aqueous oxidant flow was started at the specified rate and the loop circulation pump was switched on. (3) Monomer in a pre-emulsified form was added at the specified feed rate. The comonomers of the pre-emulsion with vinyl acetate, were monoethyl maleate, and dibutyl phthalate as per the formulation concentrations shown in Table 1. The aqueous component for the pre-emulsion included most of the water and all of the surfactants/stabilizer together with the buffer and the reducer components. (4) Soon after the oxidant feed and pre-emulsion feeds had started, the temperature increased, indicating an exothermic reaction. This reaction exotherm was controlled with cooling water passing through jackets surrounding the process pipe to maintain the reaction temperature at 60° C. The mean residence time of materials within the loop component was 7 minutes. The reactor was pressurized with a valve so that the system operated with a positive pressure of 2 bar. (5) When the process reached an equilibrium, as indicated in a constancy in conversion and particle size, a 2.5 L sample was collected in a separate atmospheric tank to which was added a small amount of oxidizer and reducer to further reduce unreacted monomer. A biocide was also added.

Table 1 shows the % concentrations for the various comonomers and surfactants. The concentration for the comonomers are expressed as a % of the total monomer. The balance of the comonomer was vinyl acetate. The concentration of surfactant is expressed as parts per hundred monomer. Example 1 did not contain comonomers (1) an ethylenically unsaturated mono or di-carboxylic acid or half ester of a di-carboxylic acid, e.g., monoethyl maleate or (2) a comonomer having a multifunctional moiety, e.g., diallyl phthalate. Examples 2A-2E used comonomers monoethyl maleate and diallyl phthalate at varying flow rates. Examples 3 and 4 used these same comonomers, but Example 3 used a different anionic surfactant and Example 4 used a different surfactant package.

TABLE 1

| | Anionics | | | | | | |
|---|---|---|---|---|---|---|---|
| | Sodium | | Sodium | | | | |
| | Sec. | | Laurylalcohol | Sodium | | Comonomers | |
| | Alkyl | Sodium | Ethoxylate | Dioctyl | Pluoronic | Monoethyl | Diallyl |
| Ex | Sulfonate | Vinylsulfonate | Sulfate | Sulfosuccinate | F-68 | maleate | phthalate |
| 1 | 1.765 | 0.442 | — | — | 0.825 | — | — |
| 2A | 2.063 | 0.442 | — | — | 0.825 | 0.3 | 0.3 |
| 2B | 2.063 | 0.442 | — | — | 0.825 | 0.3 | 0.6 |
| 2C | 2.063 | 0.442 | — | — | 0.825 | 0.45 | 0.45 |
| 2D | 2.063 | 0.442 | — | — | 0.825 | 0.6 | 0.3 |
| 2E | 2.063 | 0.442 | — | — | 0.825 | 0.6 | 0.6 |
| 3 | — | 0.442 | 2.064 | — | 0.825 | 0.45 | 0.45 |
| 4 | — | 0.41 | 0.82 | 0.41 | 20.6 | 0.45 | 0.45 |

The volume average particles sizes, Dᵥ, as measured by a Coulter Counter LS230 (laser/light scatter, range 40 to 20,000 nm) for the examples is recorded in Table 2.

TABLE 2

| Example | Dᵥ Mean (nm) |
|---|---|
| 1 | 133 |
| 2A | 490 |
| 2B | 345 |
| 2C | 380 |
| 2D | 400 |
| 2E | 420 |
| 3 | 350 |
| 4 | 359 |

The example emulsions were then utilized in coating compositions. For the examples, the coating formulation used to treat this paper substrate was formulated as follows (expressed per 100 parts dry pigment):

TABLE 3
COATING FORMULATION

100 parts No. 1 Clay
0.1 parts FinnFix 10 CMC
(carboxymethylcellulose)
0.1 parts Dispex N40V (sodium
polyacrylate pigment dispersant)
17 parts Test Binder
52--58% final coating solids
Composition pH adjusted to 8.5 w/
NH₄OH:H₂O (1:1) solution

The coating formulation examples were applied to a paper board to measure the coated sheet properties. The binder level in the coating formulations was selected to emulate commercial coating recipes. Wire wound rods were used to coat the bleached board at a target coating weight value of 12 lbs./3000 ft² (5.4 Kg/914 meters). This coating weight was selected to mimic the bleached board market. The freshly coated boards were oven dried at 260° F. (127° C.) for 30 seconds and subsequently calendered at 600 psi (4137 KPa) and 170° F. (77° C.) using 1 nip. The finished boards were conditioned 18 hours according to TAPPI standards prior to application testing. Results for the coated sheets are show in Table 4. The Examples were compared against commercial vinyl acetate polymer dispersions prepared from batch processes. These dispersion from batch processes are labeled as Resyn® 1103 and Resyn® 1190 in Table 4.

TABLE 4

| | | | | | | | | | Resyn | Resyn |
|---|---|---|---|---|---|---|---|---|---|---|
| | 1 | 2A | 2B | 2C | 2D | 2E | 3 | 4 | 1103 | 1190 |
| Emulsion | 49.0 | 49.5 | 49.3 | 49.7 | 49.9 | 49.8 | 50.5 | 50.1 | 47.4 | 49.9 |
| Solids % | | | | | | | | | | |
| Emulsion | 106 | 32 | 40 | 30 | 42 | 34 | 44 | 46 | 34 | 114 |
| Viscosity | | | | | | | | | | |
| (cps) | | | | | | | | | | |
| Coating | 52.8 | 56.5 | 56.5 | 54.7 | 55.1 | 56.3 | 55.0 | 55.3 | 54.1 | 56.4 |
| Solids % | | | | | | | | | | |
| Coating | 264 | 206 | 199 | 187 | 205 | 211 | 182 | 189 | 170 | 260 |
| Viscosity | | | | | | | | | | |
| (cps) | | | | | | | | | | |
| Coated | 12.1 ± 0.23 | 11.6 ± 0.31 | 12.0 ± 0.22 | 12.0 ± 0.19 | 12.0 ± 0.26 | 11.8 ± 0.25 | 11.5 ± 0.20 | 11.5 ± 0.18 | 11.9 ± 0.24 | 11.4 ± 0.27 |
| sheet | | | | | | | | | | |
| coating | | | | | | | | | | |
| weight | | | | | | | | | | |
| (lbs./3000 | | | | | | | | | | |
| ft²) ± 2S | | | | | | | | | | |
| 75° Gardner | 42.8 ± 2.4 | 50.0 ± 3.6 | 48.9 ± 3.6 | 49.5 ± 2.0 | 46.8 ± 3.7 | 52.6 ± 5.6 | 55.2 ± 5.6 | 53.4 ± 6.0 | 54.5 ± 2.8 | 53.5 ± 5.6 |
| Gloss ± 2S | | | | | | | | | | |
| TAPPI | 80.8 ± 0.32 | 79.8 ± 0.23 | 79.9 ± 0.14 | 79.9 ± 0.11 | 80.0 ± 0.39 | 79.9 ± 0.24 | 80.3 ± 0.23 | 80.5 ± 0.15 | 81.4 ± 0.29 | 81.3 ± 0.28 |
| Brightness ± | | | | | | | | | | |
| 2S | | | | | | | | | | |
| Parker-print | 3.3 ± 0.13 | 3.0 ± 0.12 | 3.0 ± 0.1 | 3.1 ± 0.15 | 3.2 ± 0.11 | 3.2 ± 0.24 | 3.2 ± 0.28 | 3.2 ± 0.36 | 3.1 ± 0.11 | 3.1 ± 0.14 |
| surface | | | | | | | | | | |
| roughness | | | | | | | | | | |
| (microns) ± | | | | | | | | | | |
| 2S | | | | | | | | | | |
| IGT Dry | 32 ± 6.6 | 62 ± 5.8 | 69 ± 4.0 | 71 ± 4.0 | 73 ± 5.0 | 69 ± 4.0 | 60 ± 9.4 | 6 3 ± 8.5 | 67 ± 56 | 84 ± 6.0 |
| Pick | | | | | | | | | | |
| Resistance | | | | | | | | | | |
| (cm/s) ± 2S | | | | | | | | | | |

As Table 4 shows, Examples 2 A-E, 3, and 4 show similar coating properties to the commercial batch Comparative Examples Resyn® 1103 and Resyn® 1190, including IGT Dry Pick Resistance values of 60 or greater. Example 1, which does not contain comonomers monoethyl maleate and diallyl phthalate, lacks the coating properties of the Comparative Examples and Examples 2 A-E, 3, and 4, including demonstrating a lower IGT Dry Pick Resistance.

While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of the patentable novelty which reside in the present disclosure, including all features which would be treated as equivalents thereof by those skilled in the art to which the disclosure pertains.

1. A composition comprising:
an aqueous dispersion of a polymer comprising at least the following polymerized comonomers:
vinyl acetate,
at least one ethylenically unsaturated mono or di-carboxylic acid or half ester of a di-carboxylic acid, and
at least one multifunctional comonomer,
where the dispersion is prepared by a continuous emulsion polymerization in a reactor comprising a closed loop section and a secondary line section.

2. A composition comprising:
an aqueous dispersion of a polymer comprising at least the following polymerized comonomers:
vinyl acetate,
at least one ethylenically unsaturated mono or di-carboxylic acid or half ester of a di-carboxylic acid,
and at least one multifunctional comonomer,
where the dispersion is prepared by a continuous emulsion polymerization in a polymerization reactor comprising a first section with a circulation loop with one or more inlets for raw material, a pump for circulating a reactor charge within the circulation loop, and a secondary line section not forming a closed loop connected to a discharge of the loop section.

3. The composition of claim 1, wherein the volume of the secondary line section is less than twice the volume of the loop section.

4. The composition of claim 1, wherein the polymer further comprises ethylene polymerized with the other comonomers.

5. The composition of claim 1, wherein the at least one ethylenically unsaturated mono or di-carboxylic acid or half ester of a di-carboxylic acid comprises acrylic acid, vinyl acetic acid, crotonic acid, methacrylic acid, tiglic acid, maleic acid, fumaric acid, itaconic acid, maleic acid, citraconic acid, hydromuconic acid, allylmolonic acid, mono(2-ethylhexyl) maleate, monoethyl maleate, or monobutyl maleate, preferably monoethyl maleate.

6. The composition of claim 1, wherein the at least one multifunctional monomer comprises triallyl cyanurate, triallyl isocyanurate, diallyl maleate, diallyl fumarate, dyvinyl benzene or diallyl phthalate, preferably diallyl phthalate.

7. The composition of claim 1, wherein the dispersion is stabilized with anionic and/or nonionic emulsifiers which are substantially free of alkylphenol ethoxylate surfactants.

8. The composition of claim 1, further comprising an external crosslinker, preferably ammonium zirconium carbonate and/or potassium zirconium carbonate.

9. The composition of claim 1, having a solids content of from 40 wt % to 70 wt %.

10. The composition of claim 1, wherein the polymer comprises from 70 to 98-pphm vinyl acetate and from 2 to 30 pphm of ethylene.

11. The composition of claim 1, which exhibits a volume average particle size value, Dᵥ, of at least 150 nm.

12. The composition of claim 1, further comprising a pigment selected from the group consisting of kaolin clay, calcium carbonate, titanium dioxide, plastic pigments and combinations of said pigments.

13. A coating formed by the composition of claim 1, having an % IGT Dry Pick Value greater than 60% compared to the same composition prepared using a batch process.

14. A paper or paperboard substrate coated with from about 1 g/m² to 30 g/m² of the coating composition of claim 1.
